(19) United States
(12) Patent Application Publication
(10) Pub. No.: US 2025/0029242 A1
(43) Pub. Date: Jan. 23, 2025

(54) MAGNETIC RESONANCE IMAGING APPARATUS, RECONSTRUCTION CONDITION SEARCH METHOD, AND MAGNETIC RESONANCE IMAGING SYSTEM

(71) Applicant: FUJIFILM Healthcare Corporation, Kashiwa-shi (JP)

(72) Inventors: Hiroki Shoji, Chiba (JP); Yasuhiro Kamada, Chiba (JP); Kota Hamada, Chiba (JP); Kentaroh Sunaga, Chiba (JP); Katsunari Nagashima, Chiba (JP)

(21) Appl. No.: 18/740,896

(22) Filed: Jun. 12, 2024

(30) Foreign Application Priority Data
Jul. 18, 2023 (JP) 2023-117052

(51) Int. Cl. G06T 7/00; G06T 11/00

(52) U.S. Cl. CPC G06T 7/0012; G06T 11/005; G06T 2207/10088

(57) ABSTRACT

A technique can be provided for enabling easy setting of a reconstruction condition desired by a user in a case of setting a reconstruction condition in an MRI apparatus. Raw data obtained by an MRI apparatus or intermediate data in the middle of reconstruction is stored in a device, and only a parameter related to image processing is changed later to perform reconstruction again (post-reconstruction). A part enabling a user to input an evaluation for an image subjected to the post-reconstruction is provided, and results thereof are accumulated. This evaluation result is analyzed by using statistical processing or machine learning to search for a recommended reconstruction condition and to suggest the result of the search to the user.

### CROSS-REFERENCE TO RELATED APPLICATION

The present application claims priority from Japanese patent application 2023-117052, filed on Jul. 18, 2023, with the Japan Patent Office, the content of which is hereby incorporated by reference into this application.

### BACKGROUND OF THE INVENTION

### 1. Field of the Invention

The present invention relates to a magnetic resonance imaging (hereinafter, referred to as MRI) apparatus, and more particularly, to a technique of supporting a user setting of image reconstruction conditions in an MRI apparatus.

### 2. Description of the Related Art

A contrast, a degree of suppression of an artifact, and the like of an image obtained by an MRI apparatus greatly differ depending on imaging conditions or set imaging parameters. However, as the imaging parameters set in the MRI, in addition to a FOV, a TE, a TR, a double speed ratio, and the like, there are various parameters according to a pulse sequence used for imaging, and an image quality required for the image also varies depending on a purpose of a diagnosis or the user's preference. Therefore, it is difficult to set the imaging parameters that coincide with the purpose of the diagnosis or the user's preference from the various imaging parameters.

Further, in the MRI, in a case of reconstructing raw data consisting of a nuclear magnetic resonance signal to form an image, it is necessary to set various reconstruction conditions such as selection of a reconstruction method and setting of reconstruction parameters. The optimal reconstruction conditions vary depending on a difference in an imaging target or the imaging conditions, and also depending on a user's preference.

Therefore, in the related art, for example, a condition in which various parameters are turned on/off is created, and the volunteer imaging or the like is repeatedly executed to approach a preferred image quality, or manufacturer-recommended parameters are used to avoid cumbersome work.

It is essential to set a plurality of parameters in image formation in a medical imaging apparatus as well as the MRI apparatus, and JP2015-510157A proposes an imaging system for designating reconstruction parameter values preferred by a doctor. In this technique, after the image is reconstructed, a result of the image reconstruction is fed back, and the reconstruction parameters are adjusted to perform the reconstruction again. The feedback and the re-reconstruction are repeated, and the reconstruction is finally performed to determine reconstruction parameter values desired by the doctor.

### SUMMARY OF THE INVENTION

The technique disclosed in JP2015-510157A can be easily applied to an image diagnostic apparatus, such as a CT apparatus, in which the raw data has a relatively small data amount such as projection data or radiation transmission data, but it is difficult to apply this technique to the MRI apparatus for the following reason. In an examination using the MRI apparatus, a protocol in which a plurality of times of imaging are combined is usually created, and the examination is performed according to the protocol. In the protocol creation, since the condition is set for each imaging included in the protocol, there is a huge number of combinations of the types of images, such as an imaging part and the contrast. Further, with the diversification of image filters in recent years and the advancement of the image reconstruction technique, there are a huge number of types of image processing, so that it is not realistic to apply the parameters preferred by the user to each of the types of image processing as in the technique disclosed in JP2015-510157A. In addition, it is extremely difficult for the user to combine various functions to finish a preferred image.

An object of the present invention is to solve the difficulty of optimization of reconstruction conditions in an MRI apparatus, and to provide a technique of enabling easy setting of the reconstruction conditions desired by a user.

In order to solve the above-described object, in the present invention, raw data is stored in a device, and only a parameter related to image processing is changed later to perform the reconstruction again. Hereinafter, the reconstruction performed later is referred to as post-reconstruction. Means for enabling the user to input an evaluation for the image subjected to the post-reconstruction is provided, and the results thereof are accumulated. This evaluation result is analyzed by using statistical processing or machine learning, and the analysis result is suggested to the user.

That is, an aspect of the present invention provides an MRI apparatus comprising: an imaging unit that collects a nuclear magnetic resonance signal generated by a subject; an operation unit that generates a reconstructed image of the subject by using raw data consisting of the nuclear magnetic resonance signal; and a reconstruction condition search unit that searches for a recommended reconstruction condition of the reconstructed image. The reconstruction condition search unit includes a data-for-image acquisition unit that acquires data-for-image generated by the operation unit, a post-reconstruction unit that uses the data-for-image to reconstruct an image under a reconstruction condition different from a reconstruction condition in a case where the operation unit reconstructs the image, an evaluation information collection unit that presents the image reconstructed by the post-reconstruction unit and receives a user evaluation for the image to store evaluation data in which the user evaluation and the reconstruction condition are associated with each other in a database, and an evaluation result analysis unit that analyzes the evaluation data accumulated in the database to determine the recommended reconstruction condition.

The function of the post-reconstruction unit can also be implemented by the operation unit that reconstructs the image.

Another aspect of the present invention provides a reconstruction condition search method of presenting a recommended reconstruction condition desired by a user in magnetic resonance imaging in which raw data consisting of a nuclear magnetic resonance signal is reconstructed to generate an image. The reconstruction condition search method includes: a post-reconstruction step of reconstructing the image again using the raw data or intermediate data of reconstruction; a step of receiving a user evaluation for a generated post-reconstructed image; a step of accumulating evaluation data in which a reconstruction condition of post-reconstruction and the user evaluation for the post-reconstructed image are associated with each other; and a step of analyzing the accumulated evaluation data to determine the recommended reconstruction condition.

Still another aspect of the present invention provides a magnetic resonance imaging system including: a magnetic resonance imaging apparatus that collects a nuclear magnetic resonance signal generated by a subject to generate a reconstructed image of the subject; and a data processing apparatus that analyzes data-for-image acquired by the magnetic resonance imaging apparatus to search for a recommended reconstruction condition. The data processing apparatus includes a post-reconstruction unit that uses the data-for-image obtained by the magnetic resonance imaging apparatus to reconstruct an image under a reconstruction condition different from a reconstruction condition of the image reconstructed by the magnetic resonance imaging apparatus, an evaluation information collection unit that presents the image reconstructed by the post-reconstruction unit and receives a user evaluation for the image to store evaluation data in which the user evaluation and the reconstruction condition are associated with each other in a database, and an analysis unit that analyzes the evaluation data accumulated in the database to search for the recommended reconstruction condition.

According to the aspects of the present invention, the evaluation results of the user for the image subjected to the post-reconstruction with various reconstruction parameters are accumulated, and the evaluation results are analyzed, so that it is possible to present a recommended reconstruction parameter desired by the user for a vast amount of raw data and a combination of various types of reconstruction parameters. As a result, it is possible to improve the image quality adjustment work in the MRI, and it is possible to realize the efficiency of the protocol creation by combining the series of imaging.

### BRIEF DESCRIPTION OF THE DRAWINGS

FIG. 1 is a diagram showing an overall outline of an MRI apparatus.

FIG. 2 is a functional block diagram of a computer.

FIG. 3 is a diagram showing a flow of an operation according to Embodiment 1.

FIG. 4 is a diagram showing details of image reconstruction processing.

FIG. 5 is a diagram showing an example of a reconstruction parameter setting screen in post-reconstruction.

FIG. 6 is a diagram showing an example of an input screen for an image quality evaluation.

FIG. 7 is a diagram showing an example of data stored in a database.

FIG. 8 is a diagram showing an example of an image quality evaluation result analysis unit.

FIG. 9 is a diagram showing an example of a presentation screen for a recommended reconstruction condition.

FIG. 10 is a functional block diagram of an image reconstruction unit of Modification Example 1.

FIG. 11 is a diagram showing a flow of presentation processing of a recommended reconstruction condition of Modification Example 1.

FIG. 12 is a functional block diagram of a computer of Modification Example 2.

FIG. 13 is a diagram showing an outline of a magnetic resonance imaging system.

### DESCRIPTION OF THE PREFERRED EMBODIMENTS

Hereinafter, an MRI apparatus and a data processing apparatus according to embodiments of the present invention will be described.

The MRI apparatus according to the embodiment of the present invention has a function (post-reconstruction function) of performing reconstruction again as post-processing on an image reconstructed by the MRI apparatus, and in this case, the MRI apparatus accumulates reconstruction conditions during the post-reconstruction and image quality evaluation information of a user for the image subjected to the post-reconstruction are accumulated, and analyze the accumulated information in order to search for a recommended reconstruction parameter (evaluation result analysis function). There are aspects in which a function characteristic of the present invention is realized by a computer provided in the MRI apparatus, and is realized by an independent data processing apparatus connectable to the MRI apparatus. In the following embodiment, an aspect will be described in which the computer of the MRI apparatus or a computing device attached thereto realizes the post-reconstruction function and the evaluation result analysis function.

### Embodiment 1

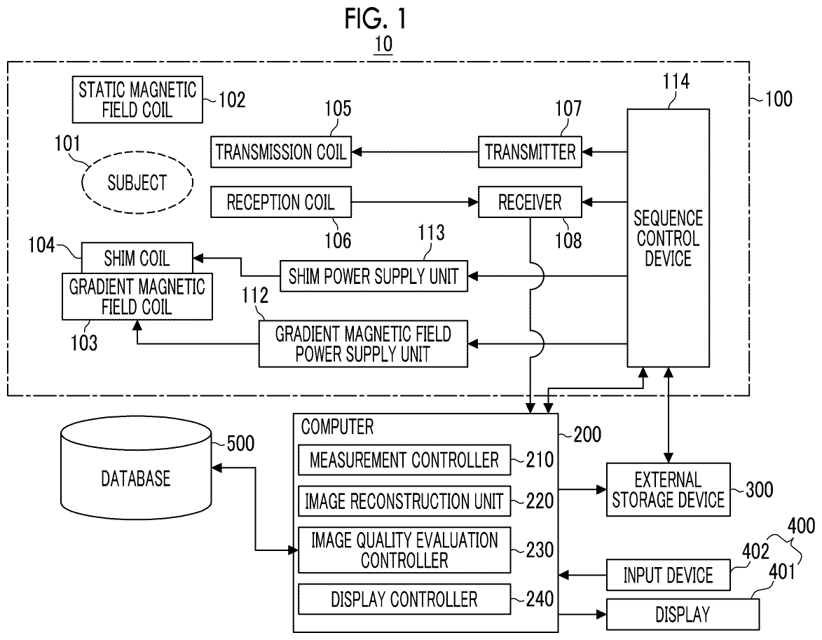

As shown in FIG. 1, the MRI apparatus 10 comprises an imaging unit 100 that causes nuclear magnetic resonance in a tissue (atom) constituting a subject 101 and collects a nuclear magnetic resonance signal, and a computer 200 that processes data consisting of the nuclear magnetic resonance signal acquired by the imaging unit 100 and controls an entire apparatus including the imaging unit 100. An external storage device 300 that stores data and programs necessary for the computation and a user interface unit (UI unit) 400 for performing communication with the user, such as a doctor or an examination technician, are connected to the computer 200. The UI unit 400 includes a display 401 and an input device 402. Further, the computer 200 can be connected to various databases 500 to exchange data with the various databases 500.

A configuration of the imaging unit 100 is the same as that of a general MRI apparatus, and as shown in FIG. 1, the imaging unit 100 comprises a static magnetic field coil (static magnetic field magnet) 102 that forms a uniform static magnetic field in an imaging space, gradient magnetic field coils 103 that provide magnetic field gradients in three axial directions orthogonal to the static magnetic field, a shim coil 104 for correcting uniformity of the static magnetic field, a transmission coil 105 for irradiating the subject 101 with a high-frequency magnetic field, a reception coil 106 for receiving the nuclear magnetic resonance signal generated from the subject 101, and a sequence control device 114.

The gradient magnetic field coils 103 in the three axial directions are each connected to a gradient magnetic field power supply unit 112 and generate a gradient magnetic field according to the power supplied from the gradient magnetic field power supply unit 112. By combining the gradient magnetic fields in the three axial directions, a gradient magnetic field of any direction and any magnitude can be generated. The shim coil 104 is also driven by a shim power supply unit 113 to generate a magnetic field that cancels an error included in the static magnetic field generated by the static magnetic field coil 102, as in a case of the gradient magnetic field coils 103.

The transmission coil 105 is connected to a transmitter 107 comprising a high-frequency magnetic field generator, a high-frequency amplifier, and the like, and irradiates the subject with the high-frequency magnetic field having a predetermined frequency as an RF pulse in response to the output from the transmitter 107.

The reception coil 106 is connected to a receiver 108 comprising an amplifier, a quadrature detector, an A/D converter, and the like. The receiver 108 samples the nuclear magnetic resonance signal by the A/D converter and transmits the nuclear magnetic sampled resonance signal to the computer 200, which is a signal processing system, as digital data.

The sequence control device 114 operates the gradient magnetic field power supply unit 112, the transmitter 107, and the receiver 108 according to a predetermined pulse sequence. Various pulse sequences are stored in the device, and in a case of the imaging, the sequence control device 114 calculates a pulse sequence to be used for the imaging based on the imaging conditions and the imaging parameters set via the input device 402 or the like, and the imaging is performed based on the calculated pulse sequence.

The computer 200 can be configured by a computer comprising a CPU and a memory, and realizes functions as controllers, such as a measurement controller 210 and a display controller 240, and a function as an operation unit, such as an image reconstruction unit 220. Further, the MRI apparatus 10 according to the present embodiment comprises an image quality evaluation controller 230 that realizes a function (function as a recommended reconstruction condition search unit) related to the evaluation of the image quality reconstructed by the image reconstruction unit 220 and the search for a recommended reconstruction condition.

The measurement controller 210 controls an operation of the imaging unit 100 via the sequence control device 114. The image reconstruction unit 220 has a function of reconstructing the image using the raw data acquired by the imaging unit 100, and a function of reading the raw data once stored in the external storage device 300 or the intermediate data in the middle of reconstruction, to perform the reconstruction again (hereinafter, referred to as post-reconstruction) under reconstruction conditions different from initial reconstruction conditions.

The image quality evaluation controller 230 has a function of collecting the image quality evaluation by the user for the image quality of the image reconstructed by the image reconstruction unit 220 or subjected to the post-reconstruction (hereinafter, simply referred to as user evaluation) to store the image quality evaluation in the database 500 in association with the reconstruction conditions of the image, a function of analyzing the user evaluation accumulated in the database 500 to search for the reconstruction condition to be recommended to the user, a function of determining the recommended reconstruction condition to present the recommended reconstruction condition to the user, and the like.

The display controller 240 mainly performs control of the display of the UI unit 400, and receives conditions such as the imaging parameters and the reconstruction parameters for the measurement controller 210 to control the imaging unit 100 or displays the image reconstructed by the image reconstruction unit 220 on the UI unit, and controls the display for prompting input of the parameters for the post-reconstruction and the user evaluation and the display for presenting the evaluation result and the recommended reconstruction condition in cooperation with the image quality evaluation controller 230.

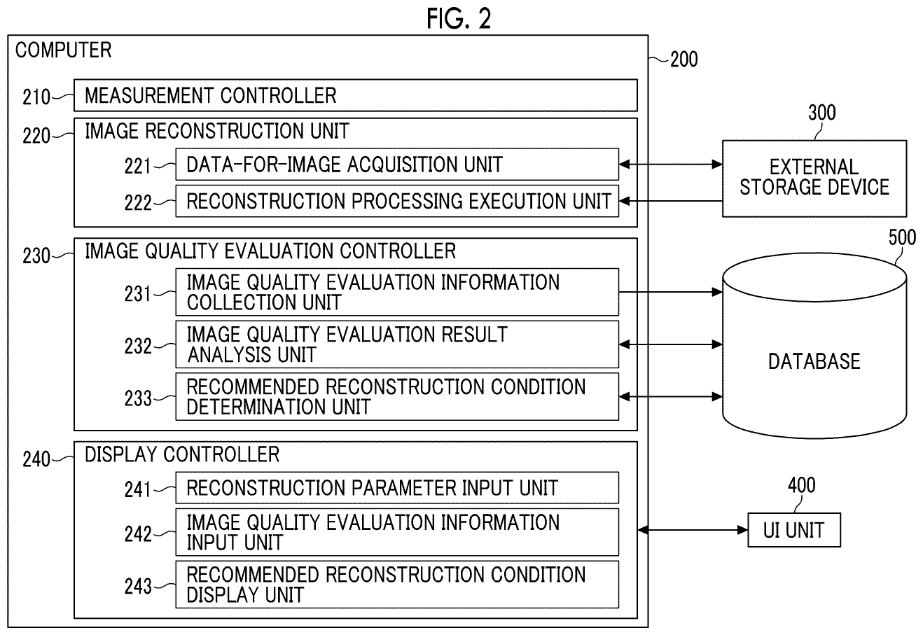

FIG. 2 shows an example of a functional block diagram of the computer 200 for realizing the above-described functions.

As shown, the image reconstruction unit 220 includes a data-for-image acquisition unit 221 that exchanges data-for-image with the external storage device 300, and a reconstruction processing execution unit 222 that executes reconstruction processing using the data-for-image. Here, the data-for-image includes raw data and intermediate data until the raw data is processed to be reconstructed into a final image. In addition, the reconstruction processing performed by the reconstruction processing execution unit 222 includes post-reconstruction using the data-for-image acquired from the external storage device 300 by the data-for-image acquisition unit 221 in addition to the processing of reconstructing the image under the initial setting conditions, and the post-reconstruction includes reconstruction in which the reconstruction is consistently performed from the raw data to the final image and reconstruction in which the remaining processing not performed on the intermediate data among a plurality of processing included in the reconstruction is executed by using the intermediate data. The data-for-image includes, as accessory information, an imaging part or the imaging conditions (imaging pulse sequence and imaging parameters), and the reconstruction conditions of the image (processing included in the reconstruction and the parameters of each processing, and information on the user who sets the reconstruction conditions).

The external storage device 300 that stores such image data includes a storage device, such as a cloud, which can exchange data with the computer 200 of the MRI apparatus 10, in addition to the storage device connected to the MRI apparatus 10, and can also be used in combination as appropriate.

The image quality evaluation controller 230 comprises an image quality evaluation information collection unit (evaluation information collection unit) 231, an image quality evaluation result analysis unit (evaluation result analysis unit) 232, and a recommended reconstruction condition determination unit 233, and the image quality evaluation information collection unit 231 collects the evaluation data of the image quality from the user via the UI unit 400 to make a database, the image quality evaluation result analysis unit 232 analyzes the collected evaluation data, and the recommended reconstruction condition determination unit 233 determines the recommended reconstruction condition, which is the analysis result. The database 500 that stores the evaluation data is not particularly limited as long as the database 500 is a large-capacity storage device capable of exchanging data with the MRI apparatus 10, similarly to the external storage device 300 that stores the image data. In FIG. 2, although the database 500 is shown as a separate element from the external storage device 300, the database 500 may be a part of the external storage device 300.

The analysis of the image quality evaluation result can adopt a method such as statistical analysis such as analysis of a selection frequency of the reconstruction conditions via a predetermined user, analysis of a distribution of the evaluation values constituting the evaluation data, or analysis via machine learning or deep learning (DL), and in a case of the machine learning, the recommended reconstruction condition can also be obtained as the output. In this case, the function of the recommended reconstruction condition determination unit 233 is included in the image quality evaluation result analysis unit 232.

The display controller 240 performs, in the execution of the functions of the image reconstruction unit 220 and the image quality evaluation controller 230, control of providing a GUI for receiving an instruction or an evaluation from the user, or a processing result to the UI unit 400, and comprises a reconstruction parameter input unit 241 that receives user designation of the parameters for the post-reconstruction, an image quality evaluation information input unit 242 that presents a GUI for inputting the evaluation data and receives image quality information (evaluation data) input via the GUI, and a recommended reconstruction condition display unit 243 that presents the recommended reconstruction condition determined by the recommended reconstruction condition determination unit 233 to the UI unit 400.

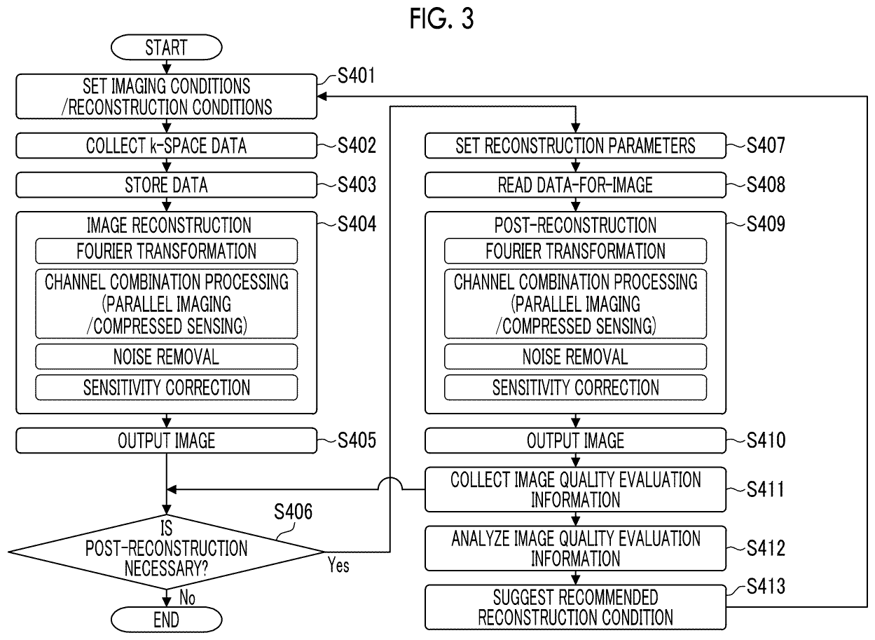

Next, an operation of the MRI apparatus according to the present embodiment will be described based on the above-described configuration. FIG. 3 shows an embodiment of the operation. Here, a case will be described in which, in the image reconstruction, four types of processing are sequentially executed, the four types of processing including processing of reconstructing the raw data via Fourier transformation, channel combination processing of combining the data for each channel obtained by a multi-channel reception coil, a noise removal, and a sensitivity correction. However, the processing included in the image reconstruction is not limited to these examples, and may further include another processing, such as processing for removing a body movement artifact or an operation using a plurality of images.

First, the imaging conditions are set in the sequence control device 114 according to the user designation or a predetermined protocol (S401), and the imaging is started. In the setting of the imaging conditions, for example, in addition to the selection of the pulse sequence used for the imaging and the imaging parameters of the pulse sequence, a reconstruction method, a correction method, parameters thereof, and the like as the conditions for the reconstruction of the image are set. In some cases, these imaging conditions are set in advance as the protocol, and in this case, the set imaging conditions are read. In a case where the imaging is started according to the imaging conditions, k-space data, which is the raw data, is collected (S402). The k-space data is temporarily stored in the memory in the computer 200, and the image reconstruction unit 220 (reconstruction processing execution unit 222) executes the reconstruction processing. In parallel with this processing, the data-for-image acquisition unit 221 stores the raw data in the external storage device 300 (S403).

The image reconstruction unit 220 performs the image reconstruction according to the set reconstruction conditions. For example, the raw data is transformed into the real space data via the Fourier transformation, the channel combination is performed, and then the noise removal and the sensitivity correction are performed (S404). In the channel combination processing, different types of processing are executed depending on the imaging conditions, such as simple multi-array coil combination (MAC combination) using a sensitivity distribution of each channel coil, parallel imaging in which data obtained by thinning out measurement is estimated using the sensitivity distribution and then channel combination is performed, and compressed sensing.

In the noise removal, for example, a filter used for the noise removal, a parameter indicating a degree of noise removal, and the like are set in advance, and the processing is performed according to these reconstruction conditions. The sensitivity correction is also performed in the same manner, and processing is performed according to the parameters such as the precision of the correction.

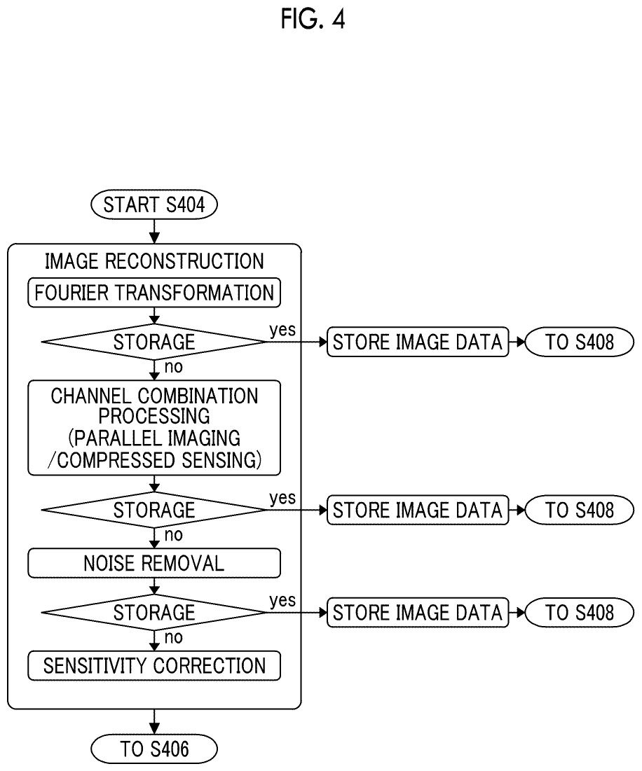

The image reconstruction unit 220 may be configured to output the image data (intermediate data) at any timing in an image reconstruction algorithm and store the image data in the external storage device 300. FIG. 4 shows a flow of processing in a case where the intermediate data is stored. In this example, a case is shown in which it is determined whether or not to store the intermediate data for each processing, and the data-for-image acquisition unit 221 acquires the intermediate data as the data-for-image in a case where it is determined to store the intermediate data, but a configuration may be adopted in which the determination step is omitted and a predetermined or all the intermediate data are stored. After being stored in the storage device, such as the external storage device 300, the intermediate data is read out by the image reconstruction unit 220 for the post-reconstruction described below (S408).

The display controller 240 displays the image generated by executing the reconstruction on the display 401 (S405).

In a case where the post-reconstruction is not necessary for the displayed image (S406), the imaging ends. On the other hand, in a case where the post-reconstruction is performed, the processing proceeds to a step of the post-reconstruction and the image quality evaluation. Whether or not to perform the post-reconstruction is determined by the user, and the user transmits a command such as the end of the imaging to the measurement controller 210 via the UI unit 400, or a GUI for confirming the necessity of the post-reconstruction is displayed to allow the user to select the necessity.

In the processing of the post-reconstruction and the image quality evaluation, first, in a case where the user sets the reconstruction parameters different from those in the reconstruction conditions used in the first reconstruction (S404) via the UI unit 400, the reconstruction parameter input unit 241 receives the setting and transmits the setting to the image reconstruction unit 220 (S407).

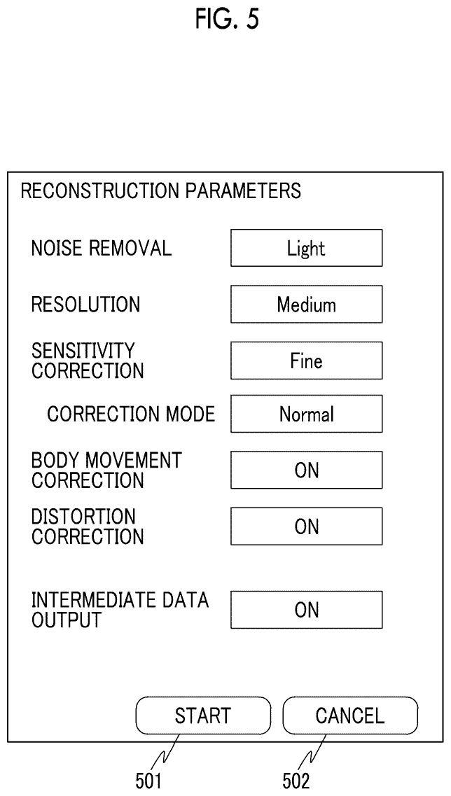

FIG. 5 shows an example of a post-reconstruction parameter reception screen displayed on the UI unit 400. In the shown example, as the set parameters, a degree of processing for four of the noise removal, the resolution, the sensitivity correction, and the correction mode, and the necessity for the body movement correction, the distortion correction, and the intermediate data output can be input, respectively. A configuration may be adopted in which the setting necessary for the processing performed before these types of processing, such as the Fourier transformation and the parallel imaging, is received.

A configuration may be adopted in which, for the input of the parameters, for example, the parameters used in the first reconstruction are displayed in a box to the right of each processing, and the parameters are changed to receive the input of new post-reconstruction parameters. The input content is determined by the operation of a “START” button 501, and the post-reconstruction is performed. The input content can be changed by operating a “CANCEL” button 502.

The “intermediate data output” is a command for giving an instruction for performing the post-reconstruction using the data generated in the middle of each processing of the reconstruction, and in a case where the “intermediate data output” is “ON”, the reconstruction processing execution unit 222 incorporates the intermediate data stored in the external storage device 300 and performs the reconstruction processing. In a case where the changed reconstruction parameter is, for example, only the parameter related to the sensitivity correction or the parameter of the processing performed after the sensitivity correction, the intermediate data obtained by the processing up to the sensitivity correction is incorporated.

The output of the intermediate data may be a part of the data instead of the entire data. For example, in a case of 3D data, the intermediate data of one or more slices in the minimum unit necessary for subsequent image confirmation (S410) may be incorporated, and the reconstruction processing may be performed.

By reading the data in the middle of the processing in this way and having the function of the post-reconstruction, the image reconstruction unit 220 need only execute the processing that remains in the reconstruction operation, so that the load of the operation can be reduced. In particular, the work efficiency can be improved by performing the processing with the intermediate data in the minimum unit necessary for the image confirmation.

In a case where the input of the reconstruction parameters for the post-reconstruction is completed (for example, in a case where the “START” button 501 is operated), the image reconstruction unit 220 reads the data-for-image that is the processing target (S408), and executes the post-reconstruction according to the reconstruction conditions set by the user (S409). In FIG. 3, the plurality of types of processing are shown in the block showing the post-reconstruction, but in a case where the data-for-image read in S408 is the intermediate data, a part of the processing is executed. The display controller 240 (image quality evaluation information input unit 242) displays the image, which is the result of the post-reconstruction, on the display 401 (S410), and displays the GUI for inputting the evaluation of the image quality by the user.

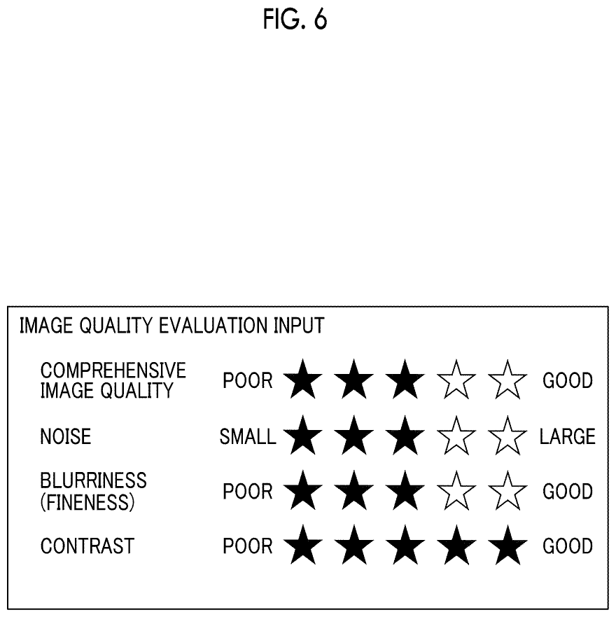

FIG. 6 shows an example of a GUI for user evaluation input. In this example, a configuration is adopted in which, as the image quality, in addition to the comprehensive evaluation, the user expresses subjective image quality indicators such as the noise, the blurriness (fineness), the contrast, and the like in five stages. A configuration may be adopted in which, as the evaluation of the image quality, only a simple evaluation, for example, a comprehensive evaluation is received according to user's skill level or preference.

The evaluation result of the user input through such a GUI is transmitted to the image quality evaluation information collection unit 231 via the image quality evaluation information input unit 242. The image quality evaluation information collection unit 231 accumulates the acquired evaluation result in the database together with the imaging conditions (imaging method and imaging parameters) of the image, the information on the user who performs the evaluation, and the like (S411).

In a case where the image quality information is collected, the processing returns to step S406, and the steps from the reconstruction parameter setting S407 to the image quality evaluation information collection S411 are repeated. The repetition is continued until it is determined in step S406 not to execute the post-reconstruction. The raw data obtained by the imaging S402 is obtained in one set in one imaging, but since the post-reconstruction can be repeatedly executed as the post-processing, the user can obtain a desired image quality image, that is, an image having a good image quality for diagnosis by repeating the post-reconstruction while changing the reconstruction conditions of the post-reconstruction.

The result of the image quality evaluation via the user obtained for each repetition is collected by the image quality evaluation information collection unit 231, accumulated in the database, and effectively used in the subsequent analysis.

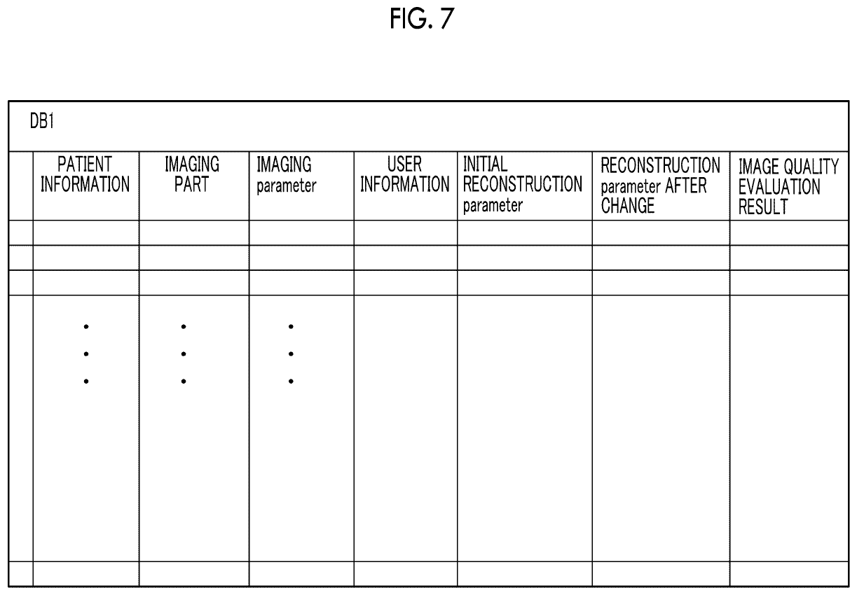

The analysis S412 via the image quality evaluation result analysis unit 232 is executed on the premise that sufficient data for performing the statistical processing on the evaluation result is collected. The sufficient data includes not only the data obtained by the repetition of the steps S407 to S411 via the same user, but also the data obtained from a large number of times of imaging and a large number of image quality evaluations performed in the past with the same or similar MRI apparatus. FIG. 7 shows an example of a structure of the database. Each time the post-reconstruction is performed, one line of data of the table in FIG. 7 is accumulated. In FIG. 7, for the purpose of simplifying the description, the items included in one line of data are limited to the patient information, the imaging conditions (imaging part and imaging parameters), the user information, the initial reconstruction parameters, the reconstruction parameters after the change, and the image quality evaluation result, but various other information accompanying the data-for-image to be handled can be accumulated. The structure of the database is not limited to the table format as shown in FIG. 7, and various structures can be adopted.

The image quality evaluation result analysis unit 232 searches for the recommended reconstruction condition for the data-for-image on which the post-reconstruction is actually performed by using a large amount of data accumulated as such a three-database (S412). As the analysis via the image quality evaluation result analysis unit 232, each evaluation item may be quantified to perform statistical analysis and select the reconstruction conditions in which the highest evaluation value is obtained, or the analysis using machine learning or AI, such as CNN (convolutional neural network), may be performed.

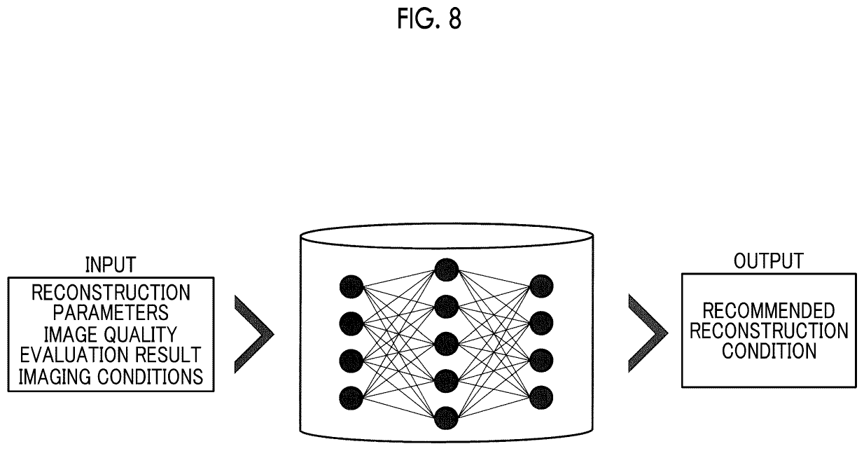

As an example, an example using the CNN is shown in FIG. 8. In this example, the CNN that has been trained to receive the input of the initial parameters, the changed parameters, the frequency used for the post-reconstruction (reflecting the user's preference), the image quality evaluation result, and the like and to output the parameters in which the image quality evaluation result is best is used, and the recommended reconstruction parameter is obtained as the output of the CNN. In addition to the items described above, the input of the CNN can include the imaging conditions or the patient information (examination part, age, sex, and the like), and in this case, the recommended reconstruction parameter according to the imaging conditions or the patient information can be output (S413).

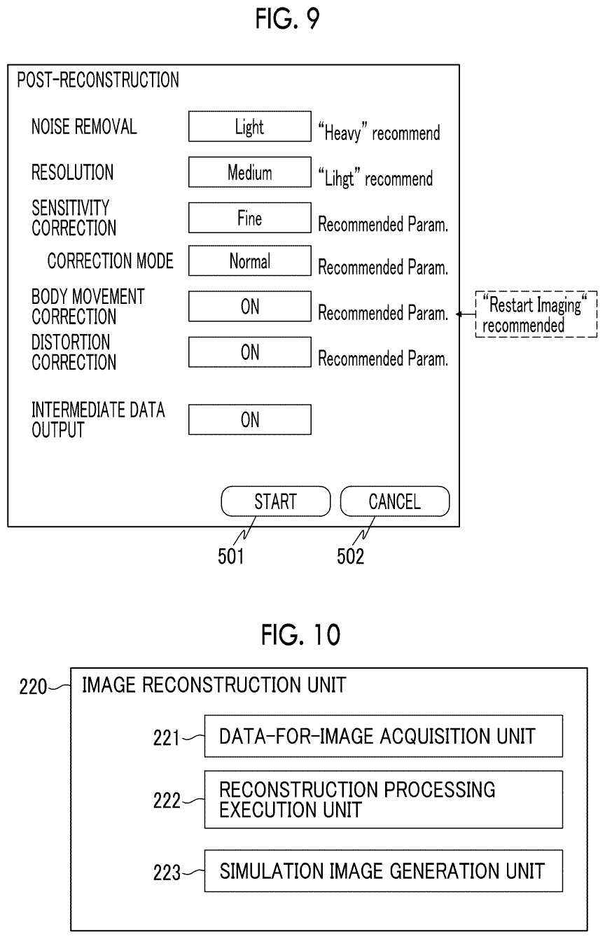

FIG. 9 shows a display example of the recommended reconstruction parameter. In the shown example, the recommended conditions for the reconstruction parameters are displayed as ““Heavy” recommend” (degree of noise removal) next to a box in which a value of each parameter is displayed. In a case where the set parameter matches the recommended condition, “Recommended Param.” is displayed. The suggestion may be performed in a comment format as necessary.

In a case where the recommended reconstruction parameter is determined, the feedback is performed to the imaging condition setting step S401 of the imaging start. In a case where the recommended reconstruction parameter is determined according to the imaging conditions or the patient information, the imaging (k-space data collection) S402 is executed with the recommended reconstruction parameter being initially set for the same imaging conditions. That is, the reconstruction conditions for obtaining the image quality desired by the user at the point in time of the start of the imaging are set.

It should be noted that, in the example of FIG. 3, the recommended reconstruction parameter is fed back to the imaging condition setting step, but the recommended reconstruction parameter may be fed back to the reconstruction parameter setting step S407, to perform the post-reconstruction again. For example, in the example shown in FIG. 9, in a case where the “START” button 501 is operated, the post-reconstruction is performed again under the recommended reconstruction condition.

As described above, by introducing a mechanism of setting the reconstruction condition setting via the user by using the original data (raw data) of the image once reconstructed or the intermediate data in the middle of the reconstruction and then performing the reconstruction again, and a mechanism of receiving the image quality evaluation of the user each time of the post-reconstruction and accumulating the image quality evaluation via the user in association with the reconstruction conditions of the image, the MRI apparatus according to the present embodiment can use the accumulated user evaluation to present the recommended reconstruction condition to the user or perform automatic setting. As a result, the user can reduce the trial and error for the reconstruction parameter setting, and can reduce the time from the imaging start to the image output.

In addition, in the MRI apparatus according to the present embodiment, since the intermediate data obtained in the middle of the reconstruction algorithm can be used in the post-reconstruction, the burden of the reconstruction operation is reduced, the time to the image output of the post-reconstruction is shortened, and the appropriateness of the set reconstruction conditions (evaluation of the image quality) can be performed in a short time. In particular, by using the data in the minimum unit as the intermediate data, the processing can be further simplified and the time can be further shortened.

### MODIFICATION EXAMPLE

The MRI apparatus according to Embodiment 1 can add an additional function to the function of performing the image quality evaluation and presenting the recommended reconstruction condition described above. Hereinafter, a modification example in which the additional function is provided will be described with a focus on the difference from Embodiment 1.

### Modification Example 1

In the present modification example, a function of presenting a simulation image is added in a case of presenting the recommended reconstruction condition.

The simulation image can be created by a program that is generally available as an “MR image simulator” that can generate an image from a human body model and any imaging parameter such as the TR or the TE. In the present modification example, as shown in FIG. 10, a simulation image generation unit 223 equipped with such a simulator program is added to the computer 200 or the image reconstruction unit 220.

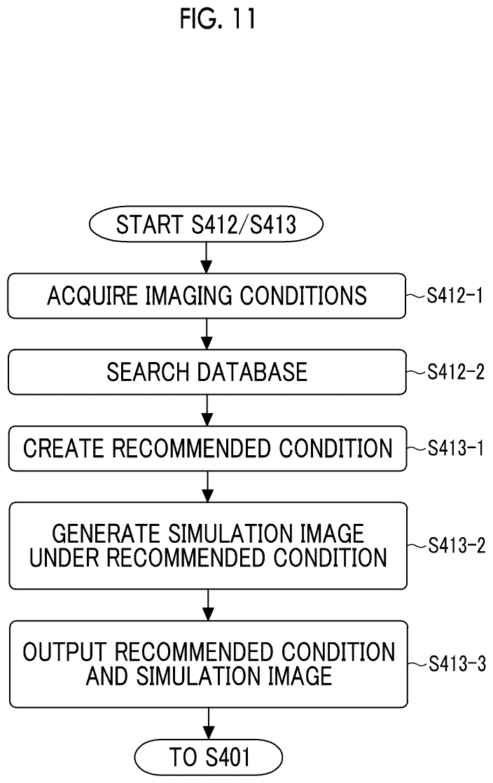

FIG. 11 shows details of the processing (FIG. 3: steps S412 and S413) in a case where the simulation image is presented.

The recommended reconstruction condition determination unit 233 acquires the imaging conditions set in step S401 from the measurement controller 21 (S412-1), searches the database (S412-2), and determines the recommended reconstruction condition by analyzing the evaluation data that coincides with the imaging conditions (S413-1). In a case where the recommended reconstruction condition is determined, the simulation image generation unit 223 reconstructs the simulation image of the imaging part by using the first-acquired imaging conditions (TR/TE and imaging part) and the recommended reconstruction condition (S413-2). Finally, the recommended reconstruction condition and the simulation image are displayed on the display 401 (S413-3).

According to the present modification example, presenting the simulation image reconstructed under the reconstruction conditions together with the recommended reconstruction condition allows the user to easily visually grasp whether or not the recommended reconstruction condition is optimal for the user.

### Modification Example 2

The present modification example is a modification example in which a function of reflecting information related to the body movement in the determination of the recommended reconstruction condition is added.

In a case where an irregular event such as the body movement occurs during the imaging, the collected k-space data is affected by the irregular event. In the MRI apparatus, various methods of monitoring the body movement have been proposed, and a method of correcting the k-space data or the image data according to the detected magnitude of the body movement has been established.

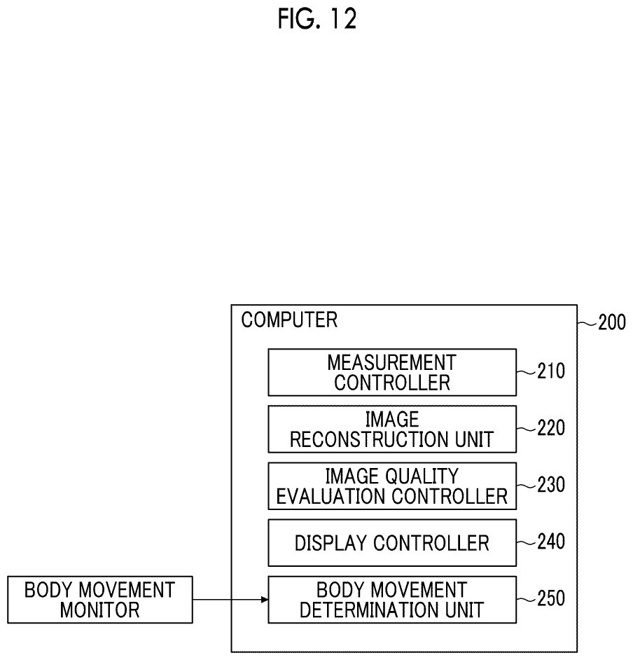

In the present modification example, the body movement correction is treated as the processing included in the image reconstruction, and the recommended reconstruction condition is also presented for the necessity of the body movement correction or a degree of the body movement correction. Therefore, as shown in FIG. 12, a body movement determination unit 250 that determines a magnitude of the body movement is added to the computer 200. In a case where the MRI apparatus has a function of incorporating body movement information from an external body movement monitor, such as an abdominal pressure gauge or a velocity sensor (body movement monitoring function), the body movement determination unit 250 acquires information, such as the magnitude, a frequency, and a period of the body movement, based on the body movement information from the body movement monitor via the function, and determines whether or not the body movement correction of the k-space data or the image data is necessary. In addition, in a case where the imaging is performed by applying a navigator echo for the purpose of detecting the body movement, the same determination may be performed from the navigator echo, or the determination may be performed based on the k-space data or the image data obtained by reconstructing the k-space data. For example, in a case of the image data, the body movement can be determined because a part where the body movement occurs has a remarkable blurriness or artifact.

The body movement determination unit 250 transmits the determination result to the recommended reconstruction condition determination unit 233. In a case where the body movement determination unit 250 determines that the body movement correction is “unnecessary”, the recommended reconstruction condition determination unit 233 recommends the body movement correction “OFF” as the recommended reconstruction condition, and in a case where the body movement determination unit 250 determines that the body movement correction is “necessary”, the recommended reconstruction condition determination unit 233 recommends the body movement correction “ON” by using, for example, a comment such as “The body movement is detected, so “ON” is recommended”.

In addition, in a case where it is determined that the body movement is at a level at which the body movement correction is difficult, for example, display of “The body movement is detected, so re-imaging is recommended” is performed in a form of a comment recommending the re-imaging, as shown by a dotted line in FIG. 9, to recommend the re-imaging.

According to the present modification example, since the processing on the body movement is included in the reconstruction conditions and the appropriate processing is recommended, it is possible for the user to be aware of the necessity of the body movement correction, and it is possible to obtain the image with a desired image quality with a small number of repetitions of the post-reconstruction.

Although the two examples have been described as modification examples of Embodiment 1, the present invention is not limited to Embodiment 1 and the modification example, and the combination of Modification Example 1 and Modification Example 2, the addition of another function, the omission of some elements, and the replacement of the elements with other elements having the same function are also included in the present invention.

### Embodiment of Magnetic Resonance Imaging System

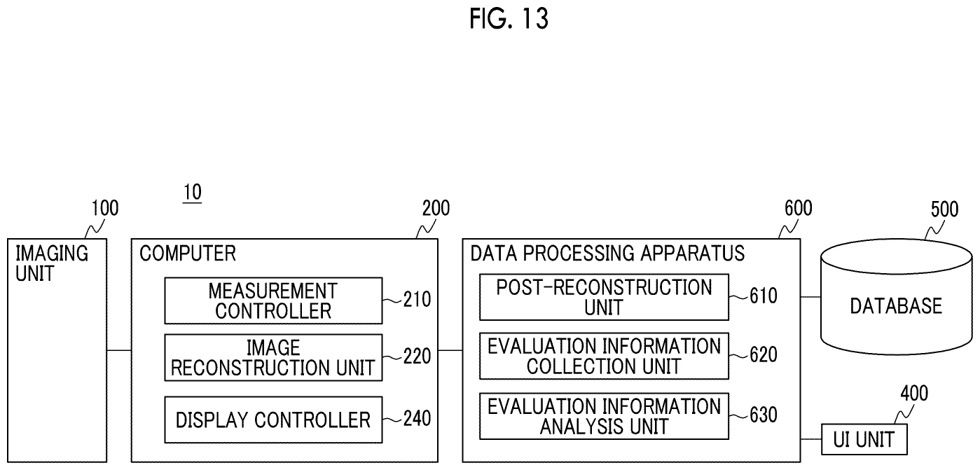

As shown in FIG. 13, the magnetic resonance imaging system according to the present embodiment consists of an MRI apparatus 10 comprising the imaging unit 100 and the computer 200, and a data processing apparatus 600. The UI unit 400 is connected to the data processing apparatus 600 as an accessory device, and is connected to the database 500. It should be noted that, although the external storage device 300 shown in FIG. 1 is omitted in FIG. 13, the MRI apparatus 10 or the data processing apparatus 600 may comprise the external storage device 300 having the same function as that in Embodiment 1 as an accessory.

The configuration of the MRI apparatus 10 is the same as that of a general MRI apparatus, and the functions of the computer 200 according to Embodiment 1, that is, the functions of the post-reconstruction and the collection and analysis of the user evaluation for the image are transferred to the data processing apparatus 600. Here, although only one MRI apparatus 10 is shown, a configuration may be adopted in which a plurality of MRI apparatuses are connected to the data processing apparatus 600 to process the data (raw data or intermediate data) obtained by the plurality of MRI apparatuses.

The data processing apparatus 600 comprises a post-reconstruction unit 610, an evaluation information collection unit 620, and an evaluation information analysis unit 630, and the functions of these units correspond to the functions of the image reconstruction unit 220, the image quality evaluation information collection unit 231, the image quality evaluation result analysis unit 232, and the recommended reconstruction condition determination unit 233 according to Embodiment 1, respectively. Therefore, the detailed description of the functions of these respective units will be omitted.

The operation of the data processing apparatus 600 is the same as in steps S407 to S413 of the processing flow shown in FIG. 3, and the data processing apparatus 600 receives the start of the processing from the MRI apparatus 10 and starts steps S407 to S413. That is, first, the post-reconstruction processing is started under the set reconstruction conditions (S407 to S409), and the image is output (S410). The user evaluation for this is received (S411), and the evaluation information is collected and made into the database by repeating this processing while changing the reconstruction conditions.

In a case where the post-reconstruction processing is received, the data processing apparatus 600 executes the evaluation information analysis processing of step S412 directly or through steps S407 to S411 to determine the recommended reconstruction condition. The determined recommended reconstruction condition may be presented to the UI unit 400 connected to the data processing apparatus 600, or may be transmitted to the MRI apparatus 10 and used for the setting of the imaging conditions in the MRI apparatus 10 (S401).

With the magnetic resonance imaging system according to the present embodiment, it is possible to provide a high additional function of presenting the recommended reconstruction condition to the existing MRI apparatus. In addition, by sharing the data processing apparatus among the plurality of MRI apparatuses, the amount of accumulated data can be significantly increased, and the accuracy of the evaluation data analysis can be improved.

It should be noted that FIG. 13 shows an example of the functional sharing between the computer 200 of the MRI apparatus 10 and the data processing apparatus 600, and various changes such as transferring some functions of the computer 200 to the data processing apparatus 600 or transferring some functions of the data processing apparatus 600 to the computer of the MRI apparatus 10, or both the computer 200 and the data processing apparatus 600 having the same function in a redundant manner are also possible, and the present invention also includes these changes.

### EXPLANATION OF REFERENCES

10: MRI apparatus
100: imaging unit
200: computer
210: measurement controller
220: image reconstruction unit
230: image quality evaluation controller
231: image quality evaluation information collection unit
232: image quality evaluation result analysis unit
233: recommended reconstruction condition determination unit
240: reconstruction parameter input unit
242: image quality evaluation information input unit
243: recommended reconstruction condition display unit
300: external storage device
400: UI unit
500: database
600: data processing apparatus

What is claimed is:

1. A magnetic resonance imaging apparatus comprising:
an imaging unit that collects a nuclear magnetic resonance signal generated by a subject;
an operation unit that generates a reconstructed image of the subject by using raw data consisting of the nuclear magnetic resonance signal; and
one or more processors configured to search for a recommended reconstruction condition of the reconstructed image,
wherein one or more processors include
a data-for-image acquisition unit that acquires data-for-image generated by the operation unit, and are configured to
perform post-reconstruction of an image by using the data-for-image under a reconstruction condition different from a reconstruction condition in a case where the operation unit reconstructs the image,
present the image reconstructed by the post-reconstruction and receive a user evaluation for the image to store evaluation data in which the user evaluation and the reconstruction condition are associated with each other in a database, and
analyze the evaluation data accumulated in the database to determine the recommended reconstruction condition.

2. The magnetic resonance imaging apparatus according to claim 1,
wherein the data-for-image acquisition unit acquires the raw data as the data-for-image.

3. The magnetic resonance imaging apparatus according to claim 1,
wherein generating the reconstructed image via the operation unit includes a plurality of stages of processing, and
the data-for-image acquisition unit acquires intermediate data generated in any of the plurality of stages of processing as the data-for-image.

4. The magnetic resonance imaging apparatus according to claim 3,
wherein the plurality of stages of processing include transformation processing of the raw data into an image space and correction processing on data in the image space, and
the data-for-image acquisition unit acquires data-for-image subjected to the transformation processing as the data-for-image.

5. The magnetic resonance imaging apparatus according to claim 1,
wherein the one or more processors are further configured to generate a simulation image using the recommended reconstruction condition, and
the simulation image is presented together with the recommended reconstruction condition.

6. The magnetic resonance imaging apparatus according to claim 1, further comprising:
a body movement determination unit that determines a body movement during imaging,
wherein the data-for-image acquisition unit acquires body movement information determined by the body movement determination unit together with the data-for-image, and
the one or more processors are further configured to present a reconstruction condition related to the body movement information as the recommended reconstruction condition.

7. The magnetic resonance imaging apparatus according to claim 1,
wherein one or more processors determine the recommended reconstruction condition via statistical processing or machine learning using the evaluation data accumulated in the database.

8. A reconstruction condition search method of presenting a recommended reconstruction condition to a user in magnetic resonance imaging in which raw data consisting of a nuclear magnetic resonance signal is reconstructed to generate an image, the reconstruction condition search method comprising:
a post-reconstruction step of reconstructing the image again using the raw data or intermediate data of reconstruction;
a step of receiving a user evaluation for a generated post-reconstructed image;
a step of accumulating evaluation data in which a reconstruction condition of post-reconstruction and the user evaluation for the post-reconstructed image are associated with each other; and
a step of analyzing the accumulated evaluation data to determine the recommended reconstruction condition.

9. The reconstruction condition search method according to claim 8, further comprising:
a step of receiving body movement information generated during imaging,
wherein a suggestion related to a body movement is presented together with the recommended reconstruction condition.

10. The reconstruction condition search method according to claim 8,
wherein the post-reconstruction step using the intermediate data consists of a reconstruction step in which processing until the intermediate data is generated from the raw data is omitted.

11. A magnetic resonance imaging system comprising:
a magnetic resonance imaging apparatus that collects a nuclear magnetic resonance signal generated by a subject to generate a reconstructed image of the subject; and
a data processing apparatus that analyzes data-for-image acquired by the magnetic resonance imaging apparatus to search for a recommended reconstruction condition,
wherein the data processing apparatus includes
a post-reconstruction unit that uses the data-for-image to reconstruct an image under a reconstruction condition different from a reconstruction condition of the image reconstructed by the magnetic resonance imaging apparatus,
an evaluation information collection unit that presents the image reconstructed by the post-reconstruction unit and receives a user evaluation for the image to store evaluation data in which the user evaluation and the reconstruction condition are associated with each other in a database, and
an analysis unit that analyzes the evaluation data accumulated in the database to search for the recommended reconstruction condition.
